(19) United States
(12) Patent Application Publication
(10) Pub. No.: US 2009/0058640 A1
(43) Pub. Date: Mar. 5, 2009

(54) Tracking device

(76) Inventor: Brett J. VanTorre, Newbury (CA)

Correspondence Address: JAMES RAY & ASSOCIATES, 2640 PITCAIRN ROAD, MONROEVILLE, PA, 15146, US

(21) Appl. No.: 12/231,249

(22) Filed: Aug. 29, 2008

Related U.S. Application Data
(60) Provisional application No. 60/966,921, filed on Aug. 30, 2007.

(51) Int. Cl. G08B 1/08

(52) U.S. Cl. 340/539.32

(57) ABSTRACT

A tracking device includes a transmitting mechanism operably disposed one of within and on a first predetermined object for transmitting a signal. A first power source is operably connected to such first transmitting mechanism for supplying power to such first transmitting mechanism. A switch mechanism is disposed intermediate such transmitting means and such first power source for selectively turning such transmitting means on and off. A receiving mechanism is operably disposed one of within and on a second predetermined object for receiving such signal from such transmitting mechanism. An alarm mechanism is operably connected to such receiving mechanism such that when such receiving mechanism receives such signal from such transmitting mechanism such alarm mechanism will produce at least one of a predetermined sound, motion and visual display. A second power source is operably connected to such receiving mechanism and such alarm mechanism for supplying power thereto.

### CROSS REFERENCE TO RELATED APPLICATION

This patent application is related to and claims priority from U.S. Provisional Patent Application Ser. No. 60/966,921 filed Aug. 30, 2007.

### FIELD OF THE INVENTION

The present invention relates, in general, to tracking devices and, more particularly, this invention relates to a device for enabling a user to locate lost articles such as handheld remote controls for electronic appliances, hand held portable electronic devices, cell phones, and the like.

### BACKGROUND OF THE INVENTION

Prior to the conception and development of the present invention, hand held remote controls for electronic appliances, television and stereo remote control devices, cell phones, handheld electronic devices, personal digital assistants, and the like have become increasingly popular. Most households boast a variety of handheld devices each of which can be difficult to keep track of. Such devices are moved around a room by individuals, may slide under couch and chair cushions, under furniture, and may be moved to improper rooms by accident. Therefore there exists a need for a tracking device for enabling a user to easily locate such devices. Moreover, there is a particular need for integration of a tracking device into electronic appliances such as televisions, media players, and the like and their corresponding hand held remote controls such that at a push of a button on one of such electronic appliances such corresponding remote control will emit a signal such as a beeping sound to enable a user to locate such corresponding remote control.

Specifically of interest to the present invention are the following: Anderson, et al, U.S. Pat. No. 4,101,873 discloses a miniaturized coded transmitter and battery powered receivers responsive to a predetermined code transmission and provided with a miniaturized audible signal generator in each receiver. When the receiver is interrogated by a specific signal, such receiver will respond audibly. The receivers are meant to be placed on commonly used objects such as eyeglasses, purses and other personal articles.

Lander, U.S. Pat. No. 4,476,469, discloses a locator means for assisting in locating an object. A hand-held ‘searcher’ includes a short-range signal transmitter powered by an internal cell or battery and having electronic circuitry for generating an address signal when activated by switching means and miniature ‘locator’ includes a transponder powered by an internal cell or battery and having electronic circuitry and signal received from the ‘search’. The ‘searcher’ may be provided with circuitry and selective switching means (for selectively addressing, with coded signals, several locators which may be placed with or on respective objects or attached thereto such as by means of a small ring.

Owen, U.S. Pat. No. 5,294,915, discloses a remote control locating device including a transmitter built into and hard wired into the circuitry of a remotely controlled electronic device and a receiver which is built into and hard wired into a remote control device which is capable of controlling the electronic device. The transmitter is adapted to operate on low power and is also adapted to transmit an FM signal upon operation of a switch. The receiver receives the FM signal transmitted from the transmitter and the receiver is also adapted to receive power from a battery contained in and adapted to power the remote control device. The receiver contains an audible signaling device adapted to be actuated upon receipt of the FM signal transmitted from the transmitter and the receiver further contains a timer adapted to deactivate the audible device upon expiration of a predetermined period of time for the purpose of saving battery usage.

Owen, U.S. Pat. No. 5,455,560, discloses a locating device for locating a remote control device which is capable of controlling an electronic device, the electronic device being stationary and the remote control device being capable of controlling the electronic device from a remote location. The locating device includes a transmitter portion incorporated within the electronic device and a receiver portion which is located within the remote control device. The transmitter portion comprises circuitry for transmitting a signal. The receiver portion comprises a first oscillator circuit which is adapted to oscillate when the transmitted signal is at the design center frequency of the first oscillator circuit. The receiver portion further comprises a second oscillator circuit which is adapted to begin oscillation after the first oscillator circuit begins to oscillate. The signal from the second oscillator circuit is amplified and provided to an audio oscillator circuit.

Wentz, U.S. Pat. No. 5,598,143, discloses a system for changing the function of a television set through a fixedly positioned signal box and a hand held remote beeper and for locating a plurality of beepers if lost including a remote control signal box located at a television set for changing the functions of the television set; a plurality of hand held beepers operatively coupled to the signal box for allowing the functions of a television set to be remotely changed; an emitter in the signal box for sending out a corresponding electrical signal to each of the beepers; a receiver in each beeper for receiving such a corresponding electrical signal, whereupon beeping noises are produced for locating each beeper.

### SUMMARY OF THE INVENTION

The present invention provides a tracking device. Such tracking device includes a signal generating means which includes a transmitting means operably disposed one of within and on a first predetermined object for transmitting a signal. A first power source is operably connected to such first transmitting means for supplying power to such first transmitting means. A switch mechanism is disposed intermediate such transmitting means and such first power source for selectively turning such transmitting means on and off. Such tracking device also includes an alarm generating means including a receiving means operably disposed one of within and on a second predetermined object for receiving such signal from such transmitting means. An alarm means is operably connected to such receiving means such that when such receiving means receives such signal from such transmitting means such alarm means will produce at least one of a predetermined sound, motion, visual display and a combination thereof. A second power source is operably connected to such receiving means and such alarm means for supplying power thereto.

According to another embodiment, a tracking device includes a housing member having a first predetermined size and a first predetermined shape. A signal generating means is disposed within such housing member and includes a transmitting means for transmitting a signal. A first power source is operably connected to such transmitting means for supplying power to such transmitting means. A switch means is disposed intermediate such transmitting means and such power source for selectively turning such transmitting means on and off. Such tracking device also includes an alarm generating means including a receiving means operably disposed at least one of within and on a predetermined object for receiving such signal from such transmitting means. An alarm means is operably connected to such receiving means such that when such receiving means receives such signal from such transmitting means such alarm means will produce at least one of a predetermined sound, motion, visual display and a combination thereof. A second power source is operably connected to such receiving means and such alarm means for supplying power thereto.

According to still another embodiment, in combination with an electronic device having a corresponding hand held remote control, a tracking device is provided which includes a signal generating means and an alarm generating means. Such signal generating means includes a transmitting means operably disposed one of within and on such electronic device for transmitting a signal. A first power source is operably connected to such transmitting means for supplying power to such transmitting means. A switch means is disposed intermediate such transmitting means and such first power source for selectively turning such transmitting means on and off. Such alarm generating means includes a receiving means operably disposed one of within and on such hand held remote control for receiving such signal from such transmitting means. An alarm means is operably connected to such receiving means such that when such receiving means receives such signal from such transmitting means such alarm means will produce at least one of a predetermined sound, motion, visual display and a combination thereof. A second power source is operably connected to such receiving means, and such alarm means for supplying power thereto.

### OBJECTS OF THE INVENTION

It is, therefore, one of the primary objects of the present invention to provide a device for aiding a user in locating a television remote control, a stereo remote control, a cell phone, a handheld electronic device, personal digital assistant, a multi-media player remote control, and the like.

Another object of the present invention is to provide a tracking device for use in combination with an electronic device and a remote control for remotely controlling such electronic device, such tracking device being for producing a signal such that such remote control may be located if lost or misplaced.

Still another object of the present invention is to provide a tracking device for selectively transmitting a signal upon the occurrence of a predetermined event, such signal may be followed by a user to locate an object to which such tracking device has been attached.

Yet another object of the present invention is to provide a tracking device which may be incorporated into electronic appliances and devices such as televisions, DVD players, stereo systems and the like and remote control devices which correspond to such electronic devices for use in enabling a user to send a signal from an electronic device to such electronic device's corresponding remote control thereby activating an alarm means within such remote control which will then produce a signal, such as a beeping noise or a light display, to enable such user to locate such remote control.

An additional object of the present invention is to provide a universal remote base for sending a signal to a receiver within or on a predetermined hand held electronic device or remote control device which would then activate a transmitter and transmit a signal such as a beeping noise to enable a user to locate such hand held electronic device or remote control device.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial schematic view of the invention according to one embodiment of the invention.

FIG. 2 is a partial perspective view of the invention according to one embodiment of the invention in which the tracking device has been incorporated into a television and television remote control.

FIG. 3 is a partial perspective view of the invention according to one embodiment of the invention in which a first housing member houses a signal generating means and has been secured to a television and a second housing member houses an alarm generating means and has been secured to a television remote control.

FIG. 4 is a partial perspective view of the invention according to one embodiment of the invention in which such first and second housings each have a securing means disposed at a predetermined location thereon.

FIG. 5 is a partial perspective view of the invention according to one embodiment of the invention in which such second housing includes a plurality of apertures for releasing sound emitted by such alarm means and a volume control means, and a light member.

FIG. 6 is a partial schematic view of the invention according to one embodiment of the invention.

FIG. 7 is a partial schematic view of the invention according to one embodiment of the invention.

FIG. 8 is a partial perspective view of the invention according to one embodiment of the invention in which the tracking device has been incorporated into an electronic device having a corresponding remote control.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

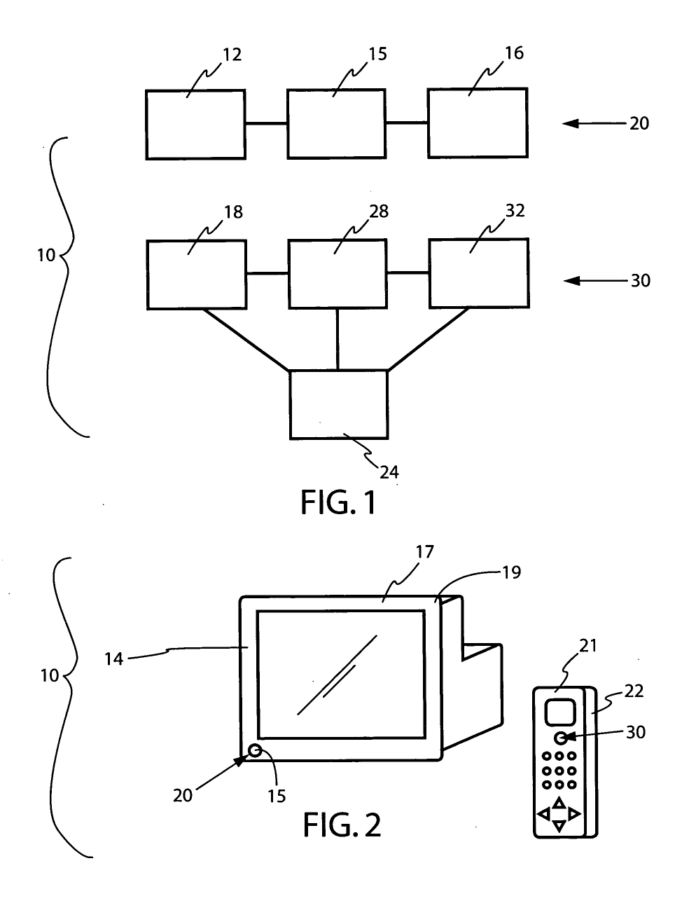

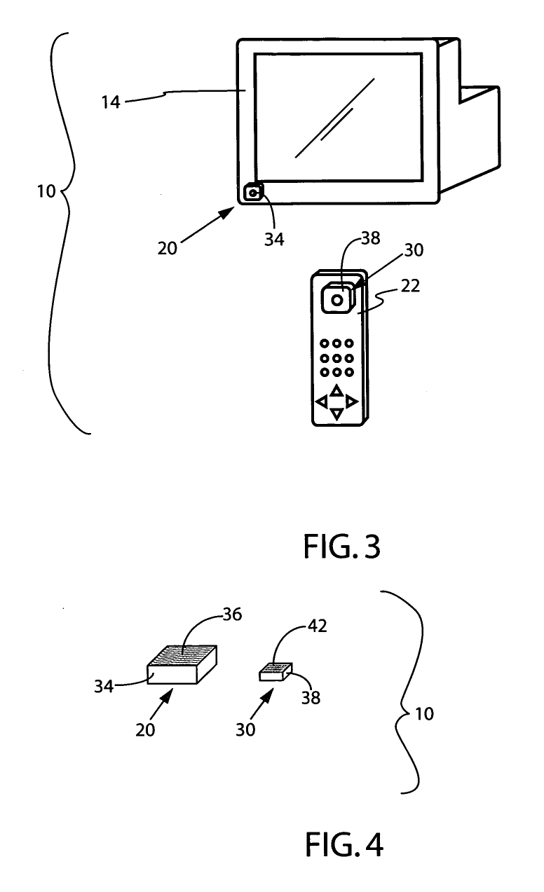

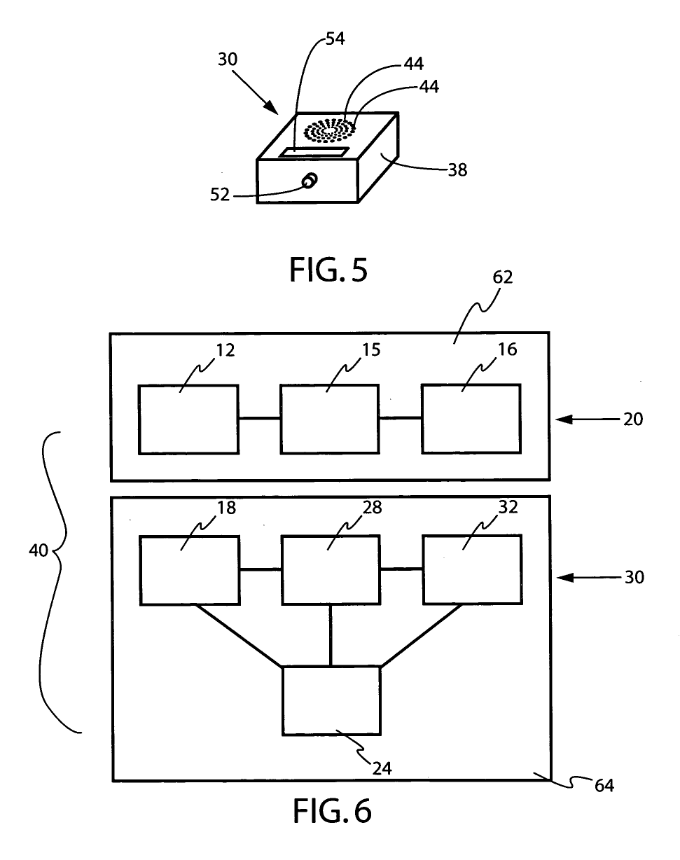

Reference is now made, more particularly, to FIGS. 1-8.

The present invention provides a tracking device, generally designated 10. Such tracking device 10 includes a signal generating means, generally designated 20.

Such signal generating means 20 includes a transmitting means 12 operably disposed one of within and on a first predetermined object 14 for transmitting a signal.

A first power source 16 is operably connected to such transmitting means 12 for supplying power to such transmitting means 12. It is presently preferred that such first power source is at least one of AC and DC power.

A switch means 15 is disposed intermediate such transmitting means 12 and such first power source 16 for selectively turning such transmitting means on and off.

Such tracking device 10 further includes an alarm generating means, generally designated 30.

Such alarm generating means 30 includes a receiving means 18 operably disposed one of within and on a second predetermined object 22 for receiving such signal from such transmitting means 12.

An alarm means 24 is operably connected to such receiving means 18 such that when such receiving means 18 receives such signal from such transmitting means 12 such alarm means 24 will produce at least one of a predetermined sound, motion, visual display and a combination thereof.

A second power source 28 is operably connected to such receiving means 18 and such alarm means 24 for supplying power thereto. It is presently preferred that such second power source is at least one battery. It is presently preferred that such at least one battery is rechargeable.

It is presently preferred that such alarm generating means 30 further includes a timing means 32 operably connected to such alarm means 24, such second power source 28, and a combination thereof for timing such at least one of such predetermined sound, motion, visual display and such combination thereof produced by such alarm means 24 such that after a predetermined amount of time has passed such alarm means 24 will cease to produce such at least one of such predetermined sound, motion, visual display and such combination thereof.

It is meant that such signal transmitting means 20 may be integrated into an electronic device 19 such as a television 17 and that such alarm generating means 30 may be integrated into a remote control device 21 which remotely controls such electronic device 19. However, the tracking device 10 is not meant to be limited as such and may be manufactured and implemented in any way which reasonably facilitates its purpose.

According to another embodiment such signal generating means 20 is contained at least in part within a first housing 34 manufactured from a second predetermined material and having a second predetermined size, a second predetermined shape, and such first housing 34 includes a first securing means 36 for releasably attaching such first housing 34 to such first predetermined object 14 at a predetermined location thereon. Such first securing means 36 may be any type of securing means which reasonably facilitates securing such first housing 34 in a desired position, for example, an adhesive type securing means may be suitable, as well as hook and loop type securing means, etc.

It is presently preferred that alarm generating means 30 is contained at least in part within a second housing 38 manufactured from a second predetermined material and having a second predetermined size and a second predetermined shape and wherein such second housing 38 includes a second securing means 42 for releasably attaching such second housing 38 to such second predetermined object at a predetermined location thereon. Such second securing means 42 may be any type of securing means which reasonably facilitates securing such first housing 42 in a desired position, for example, an adhesive type securing means may be suitable, as well as hook and loop type securing means, etc.

It is presently preferred that such second housing 38 includes a plurality of apertures 44 for releasing a predetermined sound emitted by such alarm means 24. It is presently preferred that such second housing 38 includes a volume adjustment means 52 operably connected to such alarm means 24 for adjusting a sound level of such predetermined sound.

It is presently preferred that such second housing 38 includes at least one light member 54 operably connected to such second power source 28 and such alarm means 24 such than when such alarm means 24 produces such visual display such at least one light member 54 will be energized.

According to another embodiment, referencing FIG. 6, a tracking device, generally designated 40, includes a housing member 62 having a first predetermined size and a first predetermined shape.

A signal generating means, generally designated 20, is operably disposed within such housing member.

Such signal generating means 20 including a transmitting means 12 for transmitting a predetermined signal.

A first power source 16 is operably connected to such transmitting means 12 for supplying power to such transmitting means 12. It is presently preferred that such first power source is at least one of AC and DC power.

A switch means 15 is disposed intermediate such transmitting means 12 and such first power source 16 for selectively turning such transmitting means 12 on and off.

Such tracking device also includes an alarm generating means, generally designated 30. Such alarm generating means 30 includes a receiving means 18 operably disposed one of within and on a predetermined object 64 for receiving such signal from such transmitting means 12.

An alarm means 24 is operably connected to such receiving means 18 such that when such receiving means 18 receives such signal from such transmitting means 12 such alarm means 24 will produce at least one of a predetermined sound, motion, visual display and a combination thereof.

A second power source 28 is operably connected to such receiving means 18 and such alarm means 24 for supplying power thereto. It is presently preferred that such second power source is at least one battery. It is presently preferred that such at least one battery is rechargeable.

It is presently preferred that such tracking device 10 further includes a timing means 32 operably connected to such alarm means 24, such second power source 28, and a combination thereof for timing such at least one of such predetermined sound, motion, visual display and such combination thereof produced by such alarm means 24 such that after a predetermined amount of time has passed such alarm means 24 will cease to produce such at least one of such predetermined sound, motion, visual display and such combination thereof.

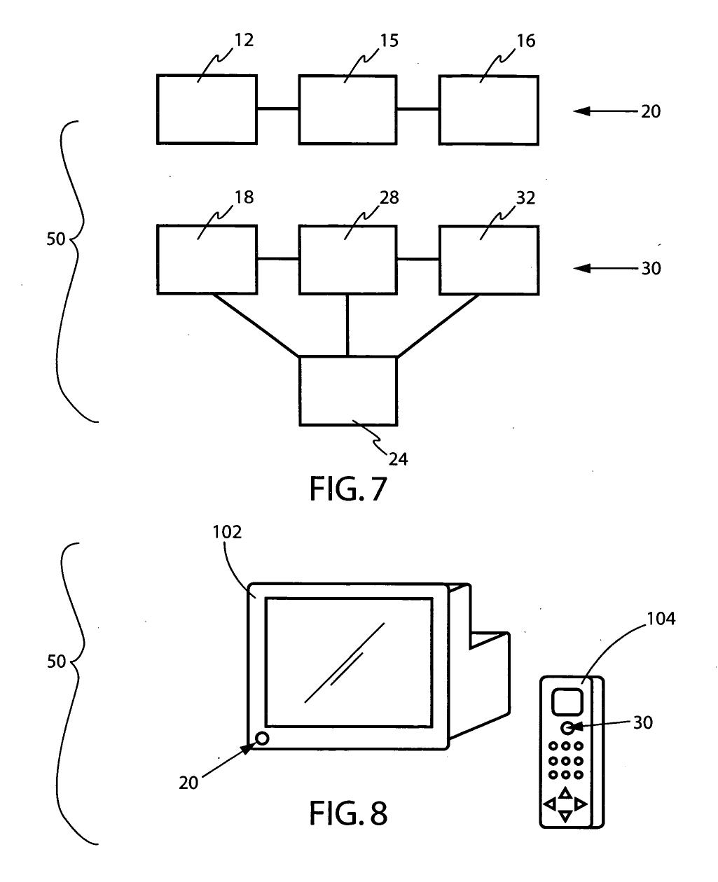

According to still another embodiment, referencing FIGS. 7-8, in combination with an electronic device 102 having a corresponding hand held remote control 104, a tracking device, generally designated 50 is provided which includes a signal generating means, generally designated 20 and an alarm generating means generally designated 30. Such signal generating means 20 includes a transmitting means 12 operably disposed one of within and on such electronic device 102 for transmitting a signal. A first power source 16 is operably connected to such transmitting means 12 for supplying power to such transmitting means 12. A switch means 15 is disposed intermediate such transmitting means 12 and such first power source 16 for selectively turning such transmitting means 12 on and off. Such alarm generating means 30 includes a receiving means 18 operably disposed one of within and on such hand held remote control 104 for receiving such signal from such transmitting means 12. An alarm means 24 is operably connected to such receiving means 18 such that when such receiving means 18 receives such signal from such transmitting means 12 such alarm means 24 will produce at least one of a predetermined sound, motion, visual display and a combination thereof. A second power source 28 is operably connected to such receiving means 18, and such alarm means 24 for supplying power thereto.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A tracking device comprising:
a. a signal generating means including;
i. a transmitting means operably disposed one of within and on a first predetermined object for transmitting a signal;
ii. a first power source operably connected to said transmitting means for supplying power to said transmitting means;
iii. a switch means disposed intermediate said transmitting means and said first power source for selectively turning said transmitting means on and off; and
b. an alarm generating means including;
i. a receiving means operably disposed one of within and on a second predetermined object for receiving said signal from said transmitting means;
ii. an alarm means operably connected to said receiving means such that when said receiving means receives said signal from said transmitting means said alarm means will produce at least one of a predetermined sound, motion, visual display and a combination thereof;
iii. a second power source operably connected to said receiving means, and said alarm means for supplying power thereto.

2. A tracking device according to claim 1 wherein said tracking device further includes a timing means operably connected to said alarm means, said second power source, and a combination thereof for timing said at least one of said predetermined sound, motion, visual display and said combination thereof such that after a predetermined amount of time has passed said alarm means will cease to produce said at least one of said predetermined sound, motion, visual display and said combination thereof.

3. A tracking device according to claim 1 wherein said first power source is at least one of AC and DC power.

4. A tracking device according to claim 1 wherein said second power source is at least one battery.

5. An alarm apparatus according to claim 4 wherein said at least one battery is rechargeable.

6. An alarm apparatus according to claim 1 wherein said signal generating means is contained at least in part within a first housing manufactured from a second predetermined material and having a second predetermined size, a second predetermined shape, and said first housing includes a securing means for releasably attaching said first housing to said first predetermined object at a predetermined location thereon.

7. An alarm apparatus according to claim 6 wherein said alarm generating means is contained at least in part within a second housing manufactured from a second predetermined material and having a second predetermined size and a second predetermined shape and wherein said second housing includes a securing means for releasably attaching said second housing to such second predetermined object at a predetermined location thereon.

8. An alarm apparatus according to claim 7 wherein second housing includes a plurality of apertures for releasing a predetermined sound emitted by said alarm means.

9. An alarm apparatus according to claim 7 wherein said second housing includes a switch means disposed on said second housing.

10. An alarm apparatus according to claim 7 wherein said second housing includes a volume adjustment means operably connected to said alarm means for adjusting a sound level of said predetermined sound.

11. An alarm apparatus according to claim 7 wherein said second housing includes at least one light member operably connected to said second power source and said alarm means such than when such alarm means produces said visual display said at least one light member will be energized.

12. A tracking device comprising:
a. a housing member having a first predetermined size and a first predetermined shape;
b. a signal generating means operably disposed within such housing member, such signal generating means including;
i. a transmitting means operably disposed one of within and on a first predetermined object for transmitting a signal;
ii. a first power source operably connected to said transmitting means for supplying power to said transmitting means;
iii. a switch means disposed intermediate said transmitting means and said first power source for selectively turning said transmitting means on and off; and
c. an alarm generating means including;
i. a receiving means operably disposed one of within and on a second predetermined object for receiving said signal from said transmitting means;
ii. an alarm means operably connected to said receiving means such that when said receiving means receives said signal from said transmitting means said alarm means will produce at least one of a predetermined sound, motion, visual display and a combination thereof; and
iii. a second power source operably connected to said receiving means and said alarm means for supplying power thereto.

13. A tracking device according to claim 12 wherein said tracking device further includes a timing means operably connected to said alarm means, said second power source, and a combination thereof for timing said at least one of said predetermined sound, motion, visual display and said combination thereof produced by said alarm means such that after a predetermined amount of time has passed said alarm means will cease to produce said at least one of said predetermined sound, motion, visual display and said combination thereof.

14. In combination with an electronic device having a corresponding hand held remote control, a tracking device comprising:
a. a signal generating means including;
i. a transmitting means operably disposed one of within and on said electronic device for transmitting a signal;
ii. a first power source operably connected to said transmitting means for supplying power to said transmitting means;
iii. a switch means disposed intermediate said transmitting means and said first power source for selectively turning said transmitting means on and off; and
b. an alarm generating means including;
i. a receiving means operably disposed one of within and on said hand held remote control for receiving said signal from said transmitting means;
ii. an alarm means operably connected to said receiving means such that when said receiving means receives said signal from said transmitting means said alarm means will produce at least one of a predetermined sound, motion, visual display and a combination thereof;
iii. a second power source operably connected to said receiving means, and said alarm means for supplying power thereto.
